(19) United States
(12) Patent Application Publication
(10) Pub. No.: US 2010/0223649 A1
(43) Pub. Date: Sep. 2, 2010

(54) Automated Assessment of Digital Video Encodings

(76) Inventors: Jason Robert Suitts, San Francisco, CA (US); Max Muller, San Jose, CA (US)

Correspondence Address: TI Law Group, 2055 Junction Avenue, #205, San Jose, CA, 95131-2116, US

(21) Appl. No.: 12/396,389

(22) Filed: Mar. 2, 2009

(51) Int. Cl. H04N 7/173

(52) U.S. Cl. 725/105

(57) ABSTRACT

Methods and systems for automating assessment of defects in digital videos are disclosed. Digital video content submitted to a digital video distribution system is encoded (e.g., transcoded) for distribution in a compact format. Portions of the encoded digital video content, referred to as video segments, that have perceived defects (e.g., transcoding artifacts) can be identified. An electronic record of the perceived defects for each of the identified segments can be created and used to automatically create a condensed defect review video that facilitates convenient and efficient assessment of the perceived defects by others. In one embodiment, the defect review video can provide for direct “side-by-side” comparison of displayed segments of the compact format and corresponding segments of the originally submitted format. Direct comparison of appearance of the perceived defects using the condensed defect review video provides for efficient assessment and disposition of perceived defects.

### BACKGROUND OF THE INVENTION

1. Field of the Invention

The present invention relates to assessment of digital videos and, more particularly, to automating assessment of digital video encodings.

2. Description of the Related Art

Digital video systems are replacing existing analog video systems and making possible the creation of many new telecommunication services (e.g., direct broadcast satellite, digital television, high definition television, video teleconferencing, telemedicine, e-commerce) that are becoming an essential part of the U.S. and world economy.

Furthermore, powered by recent advances in digital video compression technology, the different ways of delivering digital video content to viewers is increasing rapidly. In the past, viewers were constrained to watch video programming in front of a television receiver in their home. Today, people may watch digital video at any time and in any place. A viewer can now watch a video on their desktop PC or on a mobile handheld device. A process known as—transcoding—enables distribution over various networks and playback over various devices.

Digital video transcoding is the direct digital-to-digital conversion of an initial digital video encoding, into a resulting digital video encoding. This is usually done because the initial digital video encoding is so large that distribution over bandwidth limited networks is impractical, or because the initial digital video encoding is incompatible with limited display capabilities of televisions, cell phones, personal video players or other specialty consumer electronics. Accordingly, digital video transcoding overcomes such impracticality or incompatibility of the initial digital encoding by conversion into a more suitable format of the resulting encoding.

For example, a popular initial digital video encoding used by motion picture studios is Apple's ProRes 422 (HQ), which is a high-definition lossy video compression format developed by Apple Inc. for studio use in post production. Its popularity is due, at least in part, to its outstanding visual quality at full width 1920 by 1080 resolution, 4:2:2 chroma sampling, and 10-bit sample depth. Naturally, a large amount of data is used to provide encodings of such outstanding visual quality. For example, feature length movies encoded in ProRes 422 (HQ) may be as large as approximately 100-200 gigabytes (GBs) or more, which in an uncompress form may be about 600 GBs.

Accordingly, it should be understood that ProRes 422 (HQ) is an initial digital video encoding, which is intended for use in studio workflow and editing, and which is not intended or practical for end-user viewing or distribution over bandwidth limited networks. Initial digital video encodings, such as ProRes 422 (HQ), advantageously provide for retaining higher quality than typical end user digital video encodings, while consuming less disk storage as compared to disk storage consumed by uncompressed digital video alternatives.

Further, it is anticipated that initial ProRes 422 (HQ) encodings may be transcoded into resulting video encodings in suitable formats. For example, resulting AVC1 (also known as H.264) encodings provide a compact format, which is suitable for distribution over bandwidth limited networks, and for display on handheld media players, such as the iPod™ available from Apple Inc., or on networked set-top boxes, such as the AppleTV™ available from Apple Inc.

While such digital video transcoding provides many advantages, some challenges still remain. The resulting digital video encodings often include visually annoying transcoding artifacts, which are introduced by the transcoding, and which are not apparent in the initial high quality encoding. Some common examples of such transcoding artifacts include annoying jerkiness, annoying video pixilation or annoying smearing (which is localized over a sub-region portraying a fast moving object in the resulting digital video encoding.)

Such challenges are exacerbated by further difficulties, which are inherent in assessing such transcoding artifacts. To be most accurate, assessment of such transcoding artifacts digital video quality should be based on the perceived visual quality of the actual resulting digital video encoding, which is intended for end-users. Such transcoding artifacts are variable and depend (in part) upon the dynamic characteristics of the initial digital video encoding (e.g., spatial detail, motion).

Accordingly, conventional schemes for manually assessing transcoding artifacts are time consuming and labor intensive. Hence, there is a need for improved approaches for assessing transcoding artifacts in digital video encodings.

### SUMMARY OF THE INVENTION

Broadly speaking, the present invention provides a system and method for automating assessment of defects in digital videos. According to one aspect, the invention provides a system and method for automating assessment of defects, such as transcoding artifacts, in digital video encodings.

In one embodiment, the invention pertains to a method and system for submitting digital video content to a digital video distribution system for encoding (e.g., transcoding) and distribution in a compact format. Portions of the encoded digital video content, referred to as video segments, that have perceived defects (e.g., transcoding artifacts) can be identified. An electronic record of the perceived defects for each of the identified segments can be created and used to automatically create a condensed defect review video that facilitates a convenient and efficient assessment of the perceived defects by others.

The invention can be implemented in numerous ways, including as a method, system, device, or apparatus (including graphical user interface and computer readable medium). Several embodiments of the invention are discussed below.

As a media distribution system, one embodiment of the invention can, for example, include at least a media submission sub-system configured to facilitate review of a digital video stored in an electronic video file. The media submission sub-system is configured to (i) receive a defect report pertaining to one or more defects in a digital video, the defect report indicating at least a defect location for each of the one or more defects in the digital video, and (ii) form a defect review video from the digital video based on the corresponding defect locations for the identified one or more defects in the digital video as identified in the defect report.

As a method for facilitating review of a digital video stored in an electronic video file, one embodiment of the invention can, for example, include at least: receiving a defect report pertaining to one or more defects in a digital video, the defect report indicating at least a defect location for each of the one or more defects in the digital video; and automatically, through use of a computer, forming a defect review video from the digital video based on the corresponding defect locations for the identified one or more defects in the digital video as identified in the defect report.

As a method for reviewing digital videos, one embodiment of the invention can, for example, include at least: submitting digital video content to a digital video distribution system for transcoding and distribution in a compact format; transcoding the submitted digital video content into the compact format; reviewing transcoding artifacts, which are present in one or more video segments of the compact format; identifying the one or more video segments having the transcoding artifacts; and creating an electronic record of the transcoding artifacts for the identified segments.

As a computer readable medium including at least computer program code stored thereon for automating assessment of transcoding artifacts, one embodiment of the invention can, for example, include at least: computer program code of segments of submitted digital video content; computer programs code for transcoding the submitted digital video content into a compact format, wherein the compact format includes transcoding artifacts; computer program code for packaging segments of the compact format and corresponding segments of the submitted video content together into a playable file; and computer program code for providing instruction parameters in the playable file for automatically arranging playback of each of the segments of the compact format, together with the corresponding segments of the submitted video content, so as to demonstrate appearance of the transcoding artifacts in the compact format, relative to appearance of the submitted video content.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a digital video distribution system according to one embodiment of the invention.

FIG. 2 is a diagram illustrating an exemplary interface display of an electronic record for media asset review according to one embodiment.

FIGS. 3A and 3B illustrate an automatic assembly process according to one embodiment of the invention.

FIG. 4 is a simplified diagram illustrating format of a compact playable file.

FIG. 5 is a screen shot of a representative displayed user interface according to one embodiment of the invention.

FIG. 6 is a simplified diagram of a display that can be produced by another embodiment of the invention.

FIG. 7 is a simplified diagram of a display that can be produced by yet another embodiment of the invention.

FIG. 8 shows an exemplary computer system suitable for use with at least one embodiment of the invention.

### DETAILED DESCRIPTION OF THE INVENTION

The present invention provides a system and method for automating assessment of defects in digital videos. According to one aspect, the invention provides a system and method for automating assessment of defects, such as transcoding artifacts, in digital video encodings.

In one embodiment, the invention pertains to a method and system for submitting digital video content to a digital video distribution system for distribution in one or more different a compact formats.

The submission of digital video content to the distribution system can be performed in a uniform and computer-assisted manner. The submitted digital video content can then be encoded (e.g., transcoded) into a compact format for distribution. The compact format can then be reviewed to identify portions of the digital video content, referred to as video segments, that have perceived defects (e.g., transcoding artifacts). An electronic record of the perceived defects for each of the identified segments can be created by an agent performing the review. Subsequently, in one embodiment, the electronic record formed from the review process can be used to automatically assemble video clips into a compact playable file. This may provide a convenient “highlights” video which, on playback, can display segments of the compact format together with segments of the submitted digital video content, for direct “side-by-side” comparison. Direct comparison of the appearance of the perceived defects in the compact format relative to the appearance of the submitted digital video content may provide for efficient assessment and disposition of the perceived defects.

It should be understood that digital video transcoding, as the term is used herein, is the digital-to-digital conversion of the digital video encoding of submitted digital video content into the resulting digital video encoding having a compact format. In one embodiment, this may be done because the digital encoding of the submitted digital video content may be so large that distribution over bandwidth limited networks is impractical, or because the digital encoding of the submitted digital video content may be incompatible with limited display capabilities of televisions, cell phones, portable media players, or other consumer electronic products. Accordingly, digital video transcoding may overcome such impracticality and incompatibility of the digital encoding of the submitted digital video content by conversion into a more suitable resulting digital video encoding often having a more compact format.

Further, it should be understood that video transcoding artifacts, as the term is used herein, are visually annoying artifacts in segments of the digital video encoding of the compact format, which are introduced by the previously mentioned transcoding, and which are not apparent in the digital encoding of the submitted digital video content. Common examples of such video transcoding artifacts include, but are not limited to, annoying jerkiness, annoying video pixilation and annoying smearing (which localized over a sub-region portraying a fast moving object in the digital video encoding of the compact format).

Assessment is generally defined as a process of documenting, sometimes in measurable terms, knowledge, skills, attitudes or beliefs. Paper and ink documentation methods, which work well in many fields of endeavor, do not work as well for documenting a reviewing agent's assessment of video defects, such as transcoding artifacts, in digital video recordings because paper and ink do not fully capture and document the reviewing agent's dynamic visual experience of the transcoding artifacts. One embodiment of the invention documents, and may accurately capture the reviewing agent's assessment of video defects, based on the reviewing agent's perceived visual quality of the actual digital video encoding. In one embodiment, the invention automates creation of a playable highlights video, which may conveniently document the reviewer's assessment of the defects in the video content being reviewed.

The data size of the original submitted video content is often very large often too large to be shared easily or conveniently with others. In contrast, the data size of a playable highlights video (compact playable file) is usually much smaller, while still retaining a consistent timeline with the original submitted video content. As will be discussed later in greater detail, in one embodiment, the invention can reduce data size in the highlights video while still retaining the timeline of the original submitted video material by using filler content instead in place video content. The filler content can, for example, be blank or which otherwise have low data complexity.

Because the invention automates the assessment of video defects (e.g., transcoding artifacts), the invention may increase convenience and efficiency. Because the compact file of the highlights video has the small data size, it may be easily and conveniently shared with others. In accordance with one embodiment of the invention, the highlights video can be provided to a content provider of the original submitted video content, thereby communicating a reviewing agent's assessment of the video defects effectively to the content provider.

Because the highlights video is playable, the content provider may conveniently and visually experience the reviewing agent's artifact assessment. Because, the highlights video retains the original timeline of the submitted video content, the content provider may easily understand display of the video defects in corresponding timing context of the original submitted video.

Because the highlights video of the invention may show the content provider the direct “side-by-side” comparison of appearance of the video defects (e.g., transcoding artifacts) in the compact format, relative to appearance of the submitted video content. As a result, the content provider is much less likely to mistakenly blame other for video defects that may be present in the original submitted video content.

In light of the foregoing reasoning, the invention may advantageously facilitate a media distribution system in making an accurate, appropriate and simplified assessment on whether a particular video, e.g., compact video encoding, has sufficient quality to be distributed. Hence, the invention can help avoid release of inferior digital video products which might have unacceptable defects, such as annoying transcoding artifacts. Accordingly, the invention may provide for increased quality and satisfaction perceived by content providers and consumers of video content.

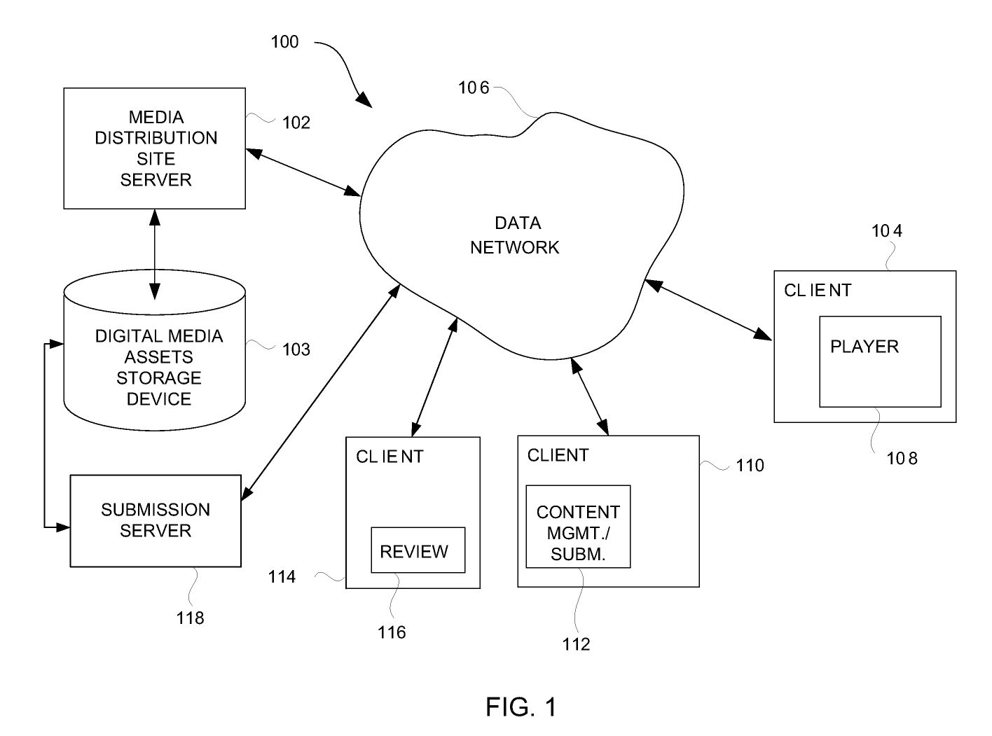

Embodiments of the invention are discussed below with reference to FIGS. 1-8. However, those skilled in the art will readily appreciate that the detailed description given herein with respect to these figures is for explanatory purposes as the invention extends beyond these limited embodiments.

FIG. 1 is a block diagram of a digital media distribution system 100 according to one embodiment of the invention. The digital media distribution system 100 includes a media distribution site server 102. Computing hardware and software of the distribution site server 102 coordinate distribution of digital media assets, such as digital video content (i.e., videos), to users. The digital media distribution system 100 stores digital media assets available for distribution in a digital media assets storage device 103. The digital media assets storage device 103 provides mass storage of the digital media assets. The media distribution site server 102 provides access to the digital media assets stored in the digital media assets storage device 103 over a data network 106.

The digital media distribution system 100 can also include or support a plurality of clients, such as a first client 104, a second client 110, and a third client 114. For simplified illustration in FIG. 1, the first client 104 is shown including a digital media player 108, the second client 110 is shown including a content management/submission interface program 112, and the third client 114 is shown including a client review program 116. However, it should be appreciated that any of these clients 104, 110 or 114 can include one or more of the digital media player 108, the content management/submission interface program 112, or the client review program 116.

The digital media player 108 is an application program (e.g., software application) that operates on the first client 104, which can be a computing device. One example of a suitable digital media player 108 is QuickTime™ or iTunes™ which are software applications offered by Apple Inc. The first client 104 is coupled to the media distribution site server 102 through the data network 106. Hence, the first client 104 can interact with the media distribution site server 102 to manage, receive and play digital media assets, such as videos, stored in the digital media assets storage device 103.

The content management/submission interface program 112 is an application program (e.g., software application) that operates on the second client 110, which can be a computing device. The content management/submission interface program 110 is used in submitting (or resubmitting) digital media content to the digital media distribution system 100. For example, a content provider might want to upgrade the quality of previously submitted digital video content by resubmitting digital video content having improved quality, such as aesthetic characteristics (e.g., better sounding audio and/or better looking video). In any case, when the content provider desires to update the prior submission, the content management/submission interface program 112 can be used to resubmit the corresponding digital content.

The digital media distribution system 100 can also include a submission server 118. The submission server 118 can process submissions of digital media assets, such as digital videos, to the digital media distribution system 100 for distribution. In one embodiment, the content management/submission interface program 112 can be used to perform a submission of a digital video to the submission server 118 via the data network 106.

The digital video content that has been submitted to the submission server 118 (e.g., via the second client 110) can be processed and reviewed to determines whether it is permitted to be made available for distribution by the media distribution site server 102. For example, in one embodiment, the submission server 118 accepts an account login corresponding to a registered content provider, and accepts submission of a digital video from the content provider. Here, the content provider operates the content management/submission interface program 112 on the client 110 to submit the digital video to the submission server 118. iTunes Producer™ or iTunes Connect™ available from Apple Inc. are one examples of software programs that are suitable for the suitable content management/submission interface program 112. For additional information on submission of media items to a media distribution system see, (i) U.S. Patent Publication No. 2004/0254883 A1; (ii) U.S. Patent Publication No. 2007/0083471 A1, (iii) U.S. patent application Ser. No. 11/946,711, filed Nov. 28, 2007, entitled “RESUBMISSION OF MEDIA FOR NETWORK-BASED DISTRIBUTION”; and (iv) U.S. patent application Ser. No. 12/354,701, filed Jan. 15, 2009, entitled “SYSTEM AND METHOD FOR CONTROLLING ONLINE STORE SERVICES AND SUBMISSION OR RESUBMISSION OF DIGITAL MEDIA CONTENT USING AUTOMATED ENDORSEMENT TICKETING”; all of which are hereby incorporated by reference herein.

Typically, the digital video being submitted to the submission server 118 has a high resolution digital video encoding. For example, content providers, such as motion picture studios, might submit digital videos in a high resolution encoding, such as ProRes 422 (HQ). However, these video files having the high resolution encoding are very large, e.g., on the order of several hundreds of gigabytes for a feature length movies. Hence, since distribution of media items by the media distribution system 100 is over the data network 106 to clients 104, 110 or 114 which often limited-display capabilities, the submission server 118 can further operate to produce at least one an alternative video file in another video encoding more suitable for data transmission and/or lower resolution devices. In one embodiment, the submission server 118 can operates to transcode the submitted video content from the high resolution format to a lower resolution format that is more compact, which can be referred to as a compact format. As an example, AVC1 video encoding (also known as H.264 encoding) is a popular compact format, which may be suitable for distribution over bandwidth limited networks, and for display on handheld media players, such as the iPod™ available from Apple Inc., or on networked set-top boxes, such as the AppleTV™ available from Apple Inc.

The client review program 116 is an application program (e.g., software application) that operates on the third client 114, which is a computing device. The client review program 116 can be used by an agent when reviewing digital video, such as the transcoded video content, for video defects. In the case of transcoding, the act of transcoding can produce defects, referred to as transcoding artifacts. These defects can be present in one or more video segments of the transcoded video content (i.e., compact format). The agent can record those video defects that are perceived in an electronic file.

The media distribution system 100 may advantageously provide for online review of digital video content, as submitted or as encoded (e.g., transcoded). Typically, the review is performed manually by an agent. In an alternative embodiment, the digital video distribution system 100, such as the submission server 118, may emulate an agent to provide fully automated objective review of objective characteristics of transcoding artifacts, for example, including (but not limited to) examination of computed Peak Signal to Noise Ratios (PSNR). Accordingly, some of the objective review may be automated in software to compare at least some of the objective characteristics of the digital video content against objective standards or policies.

Besides any objective review (i.e., computerized review), the media distribution system normally provides for online aesthetic review (i.e., subjective review) of the digital video content (typically in the compact file) to identify defects, such as transcoding defects. For example, with the client review program 116, an agent can playback and observe video appearance of the digital video content as well as playback and listen to the corresponding sound track. Creation of an electronic record of the transcoding artifacts for each of the identified segments can be facilitated by the client review program 116. For example, based on the agent's review of the resulting compact format, the video segments having the transcoding artifacts can be identified, and respective start and stop times surrounding a particular identified defect can be recorded in an electronic record.

As will be discussed in greater detail subsequently herein, the invention provides for convenient and efficient assessment of video defects, such as transcoding artifacts. In one embodiment, the submission server 118 can operate to facilitate video review and approval by automatically assembling video clips of particular segments having potential defects into a compact playable file. In one embodiment, an agent (reviewer) can examine the video to identify perceived defects, the perceived defects can then be documents in an electronic record, and then the appropriate video clips can be automatically assembled. Assessment of video defects, such as transcoding artifacts, can for example be characterized by using ITU-R BT.500-11 [Subjective Video Quality Assessment of Motion Pictures].

As mentioned previously, the digital video encoding of the submitted video content is typically very large. For example, feature length movies encoded in ProRes 422 (HQ) may be as large as approximately 100-200 gigabytes (GBs) or more. Accordingly, this very large size may otherwise have caused practical difficulties in demonstrating appearance of the transcoding artifacts in the compact format, relative to appearance of the submitted video content. However, in one embodiment, the invention can advantageously limits these difficulties by providing a convenient playable highlights video, displaying segments of the compact format together with segments of the submitted video content, for direct side-by-side comparison.

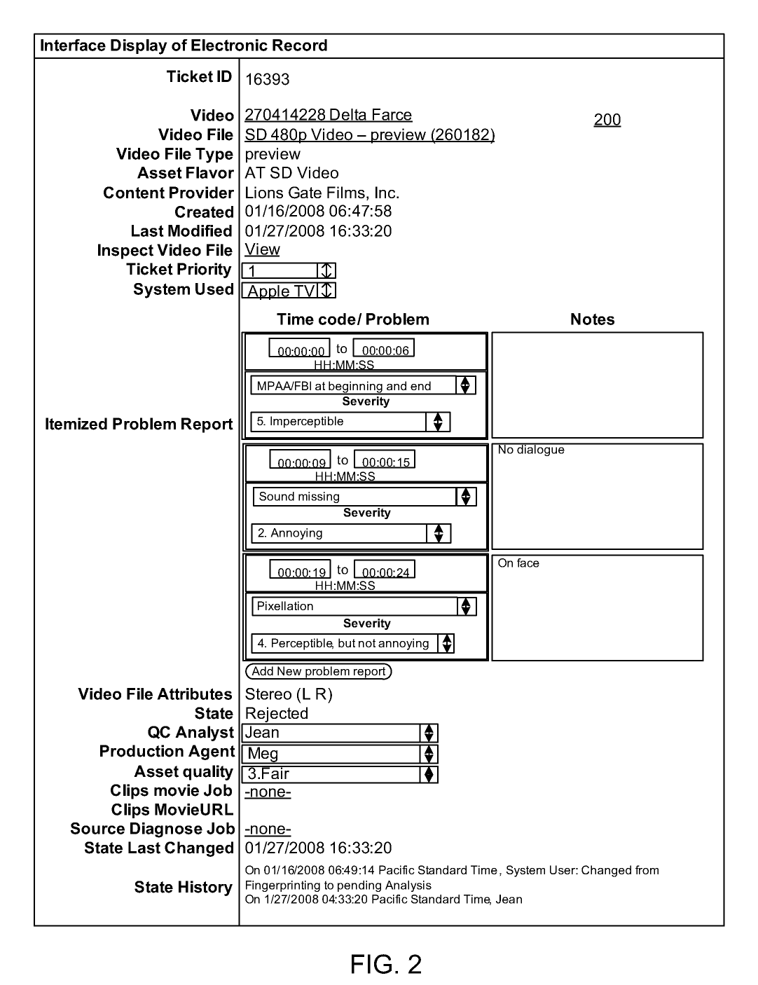

FIG. 2 is a diagram illustrating an exemplary interface display of an electronic record 200 for media asset review according to one embodiment. The media asset is, for example, video content. In one usage scenario, the video content is received at a distribution system in a high resolution format and is then processed into a lower resolution format. This resolution conversion can be referred to as transcoding since the video content is transferred from one encoding (high resolution) to another encoding (lower resolution). The resulting encoding with the lower resolution can be referred to as a compact format. Unfortunately, transcoding often yields transcoding artifacts in the encoded video. The interface display of an electronic record 200 can be used to record data concerning a review of the encoded video. For example, the electronic record can specify one or more identified segments within the encoded video that have defects, such as transcoding artifacts. The interface display of an electronic record 200 allows the defects in the encoded video to be conveniently documents and recorded to thereby for an electronic record. As shown in record interface display of FIG. 2, data of an electronic record can be displayed in tabular form.

The interface display illustrated in FIG. 2 can display data contained in the electronic record. The data can be related to identified defects (e.g., transcoding artifacts), the compact format or the submitted video content. A respective appropriately descriptive legend can be provided adjacent to display of each data item of data. For example, in one embodiment, a ticket number “16393” uniquely identifies the electronic record for the review of the compact format. The ticket number can be displayed near the top of the interface display of FIG. 2, adjacent to the appropriately descriptive legend “Ticket #”.

Through use of the interface display for an electronic record 200, data for an electronic record can entered, reviewed and/or modified by an agent (e.g., media review person). For example, the agent may add an explanation, justification or discussion of each transcoding artifact. In particular, the agent can add annotations or numbers characterizing severity of the transcoding artifacts. Examples of severity number ratings and annotations characterizing severity shown in FIG. 2 are “5. Imperceptible”, “2. Annoying”, and “4. Perceptible, but not annoying.” As will be discussed in greater detail subsequently, in one embodiment, such annotations characterizing severity of the transcoding artifacts are displayed during playback of a highlights video of the transcoding artifacts. In one embodiment, assessment of video defects, such as transcoding artifacts, can be characterized by using ITU-R BT.500-11.

As shown in FIG. 2, the agent can use the interface display to create an electronic record of suspected, possible or actual transcoding artifacts. As shown in FIG. 2, time codes and a possible pixilation transcoding artifact are documented for a particular segment of the encoded video, along with a helpful note concerning the artifact (e.g., “On face”).

In one embodiment, the interface display of an electronic record 200 include a “View” control option to allow the agent to initiate inspection of the compact format (encoded video). For example, the agent can initiate player software to play the compact format of the video content by selecting the “View” control option, which is shown adjacent to the legend “Inspect Video File”.

In one embodiment, the player software can also play the audio sound track synchronously with playing the video content. Accordingly, the agent can also review any audio defects, which are contemporaneous with one or more video segments of the compact format, and can identify the audio segments having the audio defects. As shown in FIG. 2, the agent can document such audio defects in a similar manner as other defects. In accordance one embodiment of the invention, identified segments of the sound track can be processed in some ways, which are advantageously uniform and quite similar to processing of identified video segments. For example, as shown in FIG. 2, time codes and missing sound are documented for a particular segment, along with a note saying “No dialogue.”

Similarly, as shown in FIG. 2, the agent can review other defects, such as missing MPAA/FBI warnings, which associated with one or more video segments of the compact format. As shown in FIG. 2, in one embodiment, the agent can use the interface display to document missing video in an electronic record.

In one embodiment, after the player software has played through to the end of the compact format encoding of the submitted video content and the agent has completed reviewing and identifying all of the transcoding artifacts using the interface display shown in FIG. 2, then the agent can request a server to form a defect review video (also referred to as a compact playable file or a “Clips Movie”). The defect review movie can be automatically assembled from select video clips of the compact format using the formed electronic record. In one implementation, the defect review movie (Clips Movie) can be requested or have its availability designated by a visual indicator in the interface display, such as the status “none” indicated in FIG. 2 adjacent to the legend “Clips Movie Job”.

In accordance with one embodiment of the invention, submitted digital video content has an initial data size, and video clips of the identified segments are automatically assembled into the compact playable file. The compact playable file has a smaller data size, which is substantially smaller than approximately one tenth (or preferably smaller than approximately one hundredth) of the initial data size of the submitted digital video content. For example, in one embodiment the compact playable file is relatively small, typically less than approximately one gigabyte. As pointed out previously, the file size for the submitted content is typically very large. For example, feature length movies encoded in ProRes 422 (HQ) may be as large as approximately 100-200 gigabytes (GBs) or more.

This very large size may otherwise have caused practical difficulties in reviewing and/or demonstrating defects (e.g., transcoding artifacts) in the compact format, relative to appearance of the submitted video content. However, the invention may advantageously limit these difficulties by providing convenient highlights video in a compact playable file. The highlights video can display segments of the compact format together with segments of the submitted video content for direct “side-by-side” comparison. The size of a compact playable file can also be dramatically smaller that the size of a feature length movie. In one embodiment, the size of a compact playable file can be proportional to the amount of time being covered by the video clips to present the defects. For example, if the video clips to present the defects in a sixty minute movie are two minutes in length, then the compact playable file will be 1/30^{th} of the size of the full movie.

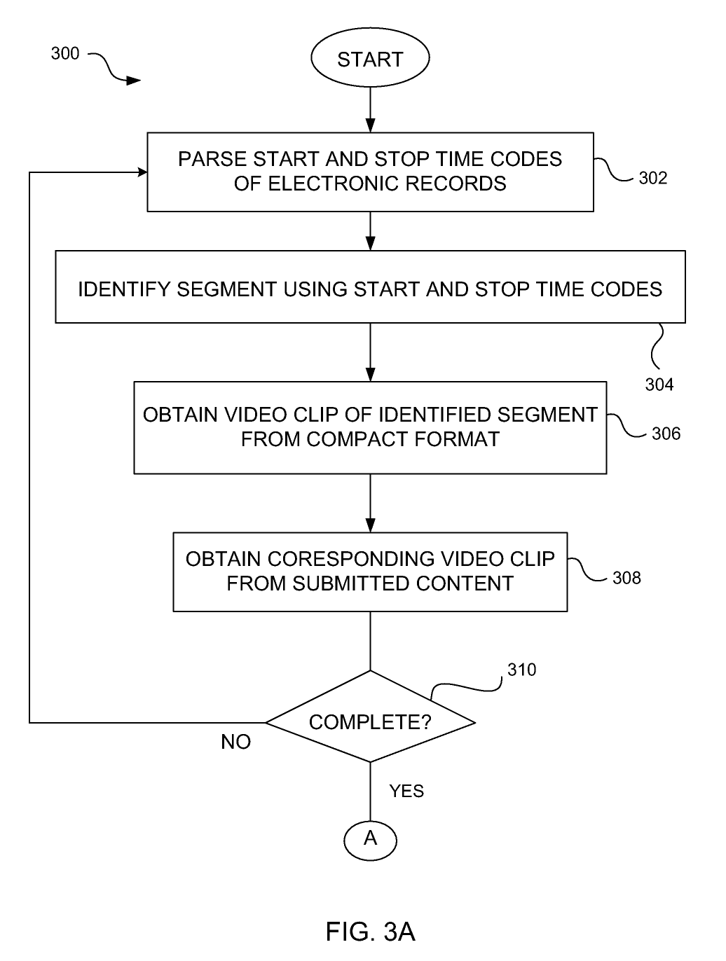

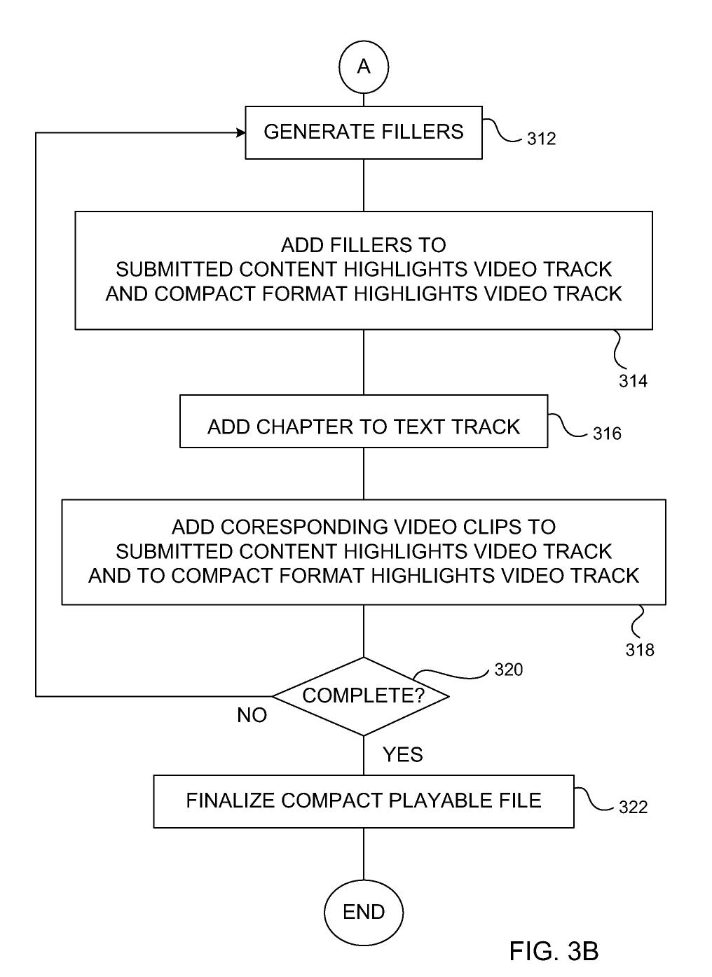

FIGS. 3A and 3B illustrate an automatic assembly process 300 according to one embodiment of the invention. The process 300 is, for example, performed automatically by a server, such as the submission server 118 illustrated in FIG. 1.

The automatic assembly process 300 can starts when an agent requests a compact playable file (or defect review video). The compact playable file can generally result from assembling video clips of identified segments. Start and stop time codes of can be parsed 302 from an electronic record. The electronic record contains information on defects of a video that has been reviewed, such as by an agent. As discussed herein, the video is a video encoding and the defects pertain to at least transcoding artifacts. Using the start and stop time codes, video segments having the transcoding artifacts can be identified.

Video clips of the identified segments are obtained 306 from the compact format. Here, the video portions of the compact format corresponding to the identified segments can be extracted from the compact format. The time codes obtained by the parsing 302 serve to specify the desired video portions from the compact portion. Similarly, video clips of the identified segments are also obtained 308 from the submitted video content. The submitted video content has time codes and an original natural timeline. When the submitted video content is transcoded to form the compact format, the compact format maintains the same (matching) time codes and the same (matching) original natural timeline as the submitted video content. Accordingly, the same (matching) time codes can be used to identify and retrieve corresponding video clips from the submitted video content.

In accordance with one embodiment, the identified segments of the compact format and corresponding identified segments of the submitted video content can be packaged into the compact playable file being assembled. Time codes of the identified segments of the compact format are paired with substantially matching time codes of the identified segments of the submitted video content. For example, initial time codes (start and stop) are parsed from the electronic records, and are used to identify an initial video segment of the compact format having a particular transcoding artifact. An initial video clip of the identified segment is edited from the compact format. Similarly, a corresponding initial video clip is edited from the submitted video content.

The automatic assembly process 300 continues in FIG. 3A with a decision 310 that determines whether parsing of all of the time codes of the electronic record is complete. If the decision 310 determines that the parsing of all the time codes has be completed, then all the need video clips from the compact format and from the submitted video content have been obtained 308 and 308 and thus the automatic assembly process 300 continues as shown in FIG. 3B. However, if the decision 310 determines that the foregoing is not complete, then processing loops back and continues to sequentially parse 302 the time codes of the electronic record and obtains 306 and 308 the desired video clips until all time code parsing and all obtaining of video clips for all video segments identified by the electronic record has been completed.

In one embodiment, the automatic assembly process 300 provides for the reduced data size of the highlights video (while still retaining the original, natural timeline) by using filler content. The filler content is normally blank or otherwise contains low data complexity. As mentioned previously, the submitted digital video content and the compact format have a common natural timeline. Accordingly, it should be understood that the natural timeline can be retained by advantageously using appropriately time matching lengths of filler content between the obtained video clips of the compact format and also between the corresponding video clips of the submitted video content, as the highlights video is assembled and packaged into the compact playable file. As shown in FIG. 3B the fillers can be generated 312 using the parsed time codes of the electronic records so that the fillers are of the appropriate duration (i.e., appropriately timed). The fillers are added 314 to the compact playable file being assembled in accordance with the timeline.

The compact playable file can also have a text track added 316. The text track can chapters to the compact playable file. Each chapter can specify a start point (and perhaps an end point) for each of the video clips so as to provide convenient skipping to any of the start points of the video clips, thereby skipping over any filler content during playback of the compact playable file. The text track can alternatively or additionally include text from the previously mentioned notes, annotations or severity indication within the electronic record. The video clips previously obtained 306 and 308 are added 318 to the compact playable file. As a result, the compact playable file can include (i) a first video track containing the obtained video clips of the compact format as well as the appropriate fillers, and (ii) a second video track containing the obtained video clips of the submitted content as well as the appropriate fillers.

The process 300 continues in FIG. 3B with a decision 320 that determines whether adding filler and chronologically ordered video clips to the compact playable file are complete. When the decision 320 determines that the foregoing has been completed, then the automatic assembly process 300 continues as shown in FIG. 3B. However, if the decision 320 determines that the foregoing is not complete, then the automatic assembly process loops back to sequentially adding filler and chronologically ordered video clips to the tracks of the compact playable file until the video tracks are complete. After the decision 320 determines that the foregoing is complete, all the fillers and the video clips have been added to the first and second video tracks of the compact playable file, the first and second video tracks have the same time codes and the same original natural timeline as the submitted video content. At this point, the first and second video tracks (and text track if provided) are complete, and the can the compact playable file can be finalized 322. Once finalized, the compact playable file can include: (i) a first video track containing the obtained video clips of the compact format as well as the appropriate fillers, (ii) a second video track containing the obtained video clips of the submitted content as well as the appropriate fillers, and a text track containing chapters and/or information pertaining to segments. The compact playable file can also include at least one audio track.

Accordingly, it should be understood that the automatic assembly process 300 provides for obtaining video clips of a set of the identified segments of the compact format, and for obtaining video clips of identified segments of the submitted video content, where each of the identified segments of the submitted video content can corresponds to a respective member of the set of identified segments of the compact format. The automatic assembly process 300 can automatically arrange the video clips of the identified segments in a selected, chronological ordering. More specifically, video clips of the identified segments of the compact format can be automatically arranged in a selected chronological ordering, and video clips of the identified segments of the submitted video content can be automatically arranged in the selected chronological ordering, where each of the identified segments of the submitted video content corresponds to a respective member of the set of identified segments of the compact format.

The video tracks are automatically assembled from the sequential arrangement of the video clips of the identified segments into the compact playable file, which provides a highlights video. Within the compact playable file, the identified segments of the compact format and corresponding identified segments of the submitted video content can be automatically arranged in parallel chronological order.

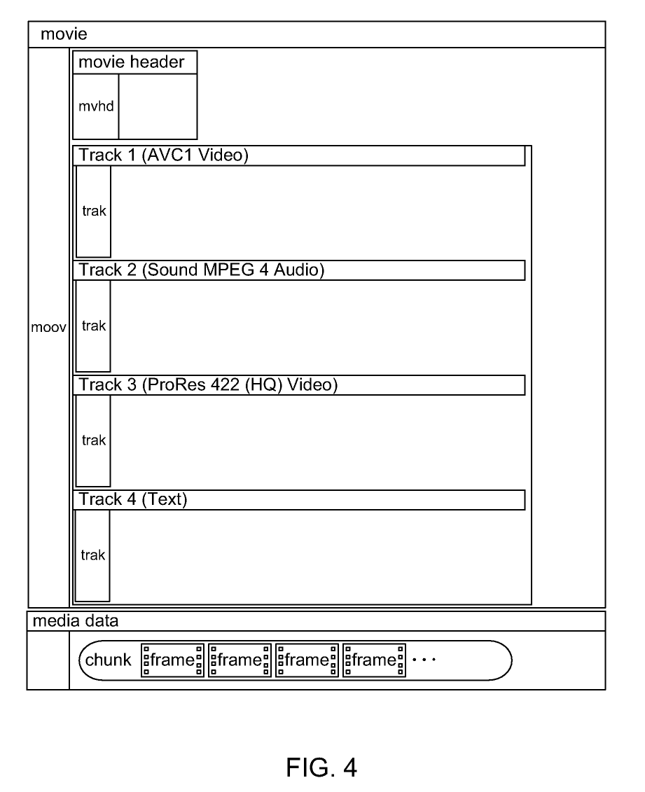

In one embodiment, the compact playable file can be considered a container file. For example, in one embodiment, four tracks are packaged together into a compact playable QuickTime container file, along with related media atoms and media data atoms. A helpful reference for technical details about QuickTime is found in the comprehensive document entitled “QuickTime File Format Specification,” dated Sep. 4, 2007 and available from Apple Inc. In one embodiment: Track 1 is an AVC1 video track encoding, which has been referenced previously as the first track containing video clips from the compact format; Track 2 is a sound track in MPEG4 Audio format encoding; Track 3 is a ProRes 422 (HQ) video track encoding, which has been referenced previously as the second track containing video clips from the submitted video content; and Track 4 is the previously referenced text track. These four tracks along with a header are further illustrated in FIG. 4 in a simplified diagram of the format of an exemplary compact playable QuickTime container file.

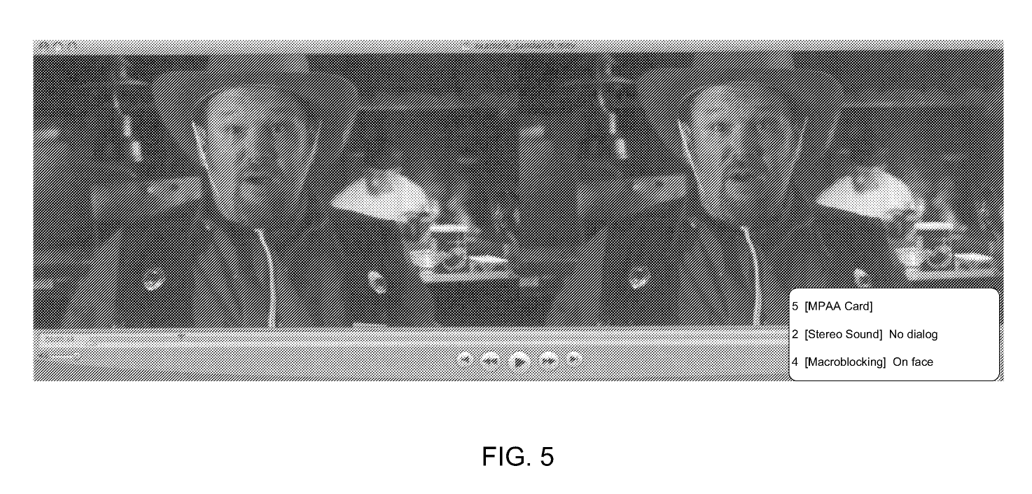

FIG. 5 is a screen shot of a representative displayed user interface according to one embodiment of the invention. The displayed user interface can be produced when playing video clips contains in a compact playable file. Time codes are used for synchronously displaying playback of both video clips pertaining to the segments of the compact format and video clips pertaining to the segments of the submitted video content as shown in FIG. 5. In the compact playable file, instruction parameters can be included to control playback features. For example, one instruction parameter can automatically and simultaneously arrange playback of each of the identified segments of the compact format together with the corresponding identified segments of the submitted video content. In one implementation, the instruction parameter can specify a display region on a display screen where a video playback window is to be provided. For example, the instruction parameter can, such as shown in FIG. 5, can cause two adjacent video playback windows to be simultaneously presented on a display screen. In such an implementation, any defects present in the compact format are shown for review in a left-side video playback window, and the corresponding video from the submitted video content is shown in a right-side video playback window. The side-by-side display allows convenient presentation of the transcoding artifacts in the compact format, relative to appearance of the submitted video content. In addition, text from the text track of the compact playable file can include information and/or instruction parameters for displaying information. This information, such as review information, can be presented as shown in the right side text box in FIG. 5. The information can include annotations characterizing severity of the transcoding artifacts.

In one embodiment, the submitted video content has the ProRes 422 (HQ) encoding has a display resolution of 1920 by 1080. The compact format in the AVC1 encoding has a display resolution of 640 by 480, which is lower than the 1920 by 1080 resolution of the submitted video content. In the playable file, instruction parameters can be included in the ProRes 422 (HQ) video track (or elsewhere in the playable file) for automatically scaling down the resolution of the video clips of the submitted video content during playback, so as to substantially match playback display of the lower video resolution of the video clips of the compact format. Hence, when both tracks are displayed in simultaneous adjacent playback display regions of the same size as shown in FIG. 5, review of the defects in the compact format can be easily and efficiently compared to the submitted video content presented in the same resolution.

Appendix A provides a more detailed textual description of characteristics and format of a compact playable file illustrated in FIG. 4. Further, it should be understood that the characteristics and format of the compact playable file, which are described in detail in Appendix A, is used in appropriately generating and arranging appearance of the display, such as depicted in FIG. 5, for review of video clips. In particular, the previously mentioned instruction parameters can be provided for each of the four tracks of the compact playable file illustrated in FIG. 4. Appendix A contains instruction parameters of each of the four tracks. The instruction parameters in Appendix A use QuickTime atoms and format conventions which are further explained in a document entitled “QuickTime File Format Specification,” dated Sep. 4, 2007 and available from Apple Inc.

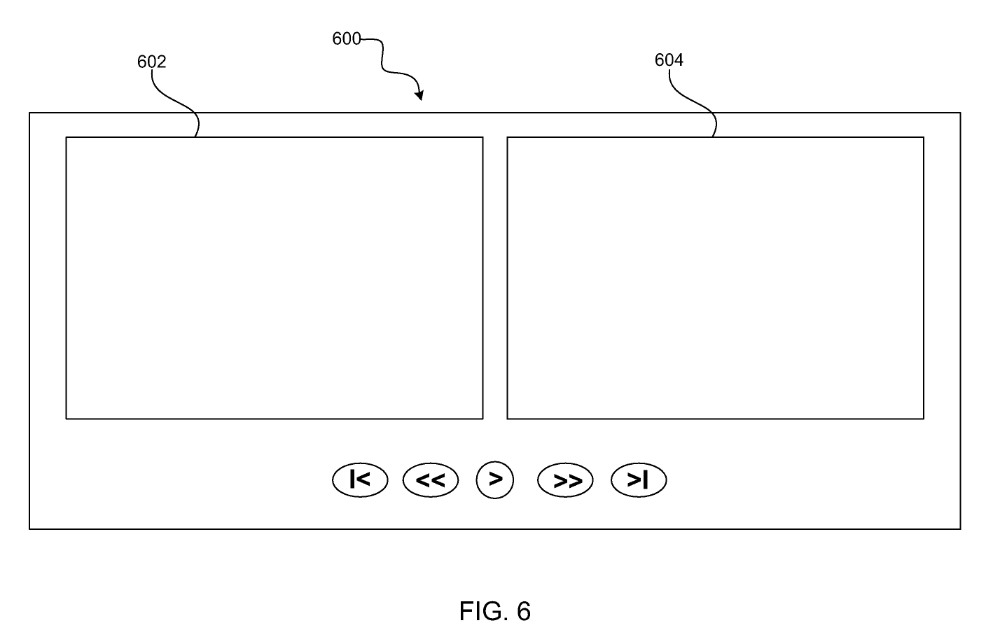

FIG. 6 is a simplified diagram of a display that can be produced by another embodiment of the invention. As mentioned previously with respect to the FIG. 1 and the media distribution system, a content provider may elect to resubmit, and provide a revised version of the digital video content. In the embodiment of the invention illustrated in FIG. 6, segments of the resubmitted video content can be identified using an electronic record discussed previously. The identified segments of the resubmitted video content and corresponding identified segments of the submitted video content can be packaged into a playable file. The playable file can include instruction parameters for automatically arranging playback. In FIG. 6, playback of each of the identified segments of the resubmitted video content can be displayed together with the corresponding identified segments of the submitted video content, so as to demonstrate 600 appearance of the resubmitted video content 604 relative to appearance of the submitted video content 602.

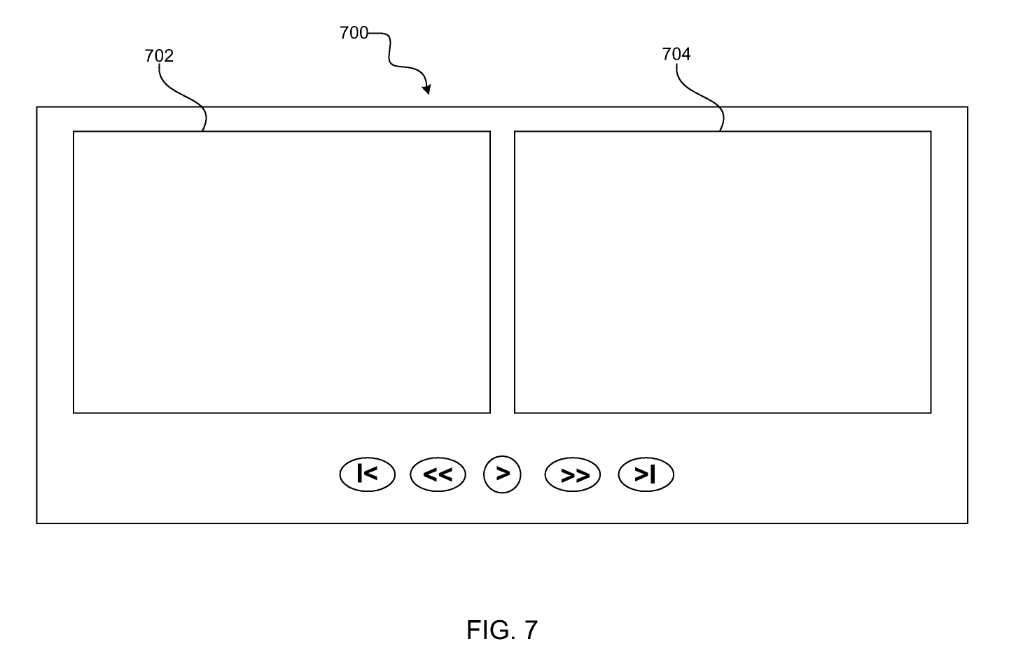

FIG. 7 is a simplified diagram of a display that can be produced by yet another embodiment of the invention. In the embodiment of the invention shown in FIG. 7, the submitted digital video content is re-transcoded using a revised process into a revised compact format. Segments of the revised compact format are identified using the electronic record previously formed. The identified segments of the revised compact format and corresponding identified segments of the compact format are packaged into a playable file, which includes instruction parameters in video tracks of the file, for automatically arranging playback. In FIG. 7, playback of each of the identified segments of the revised compact format can be displayed together with corresponding identified segments of the compact format, so as to demonstrate 700 appearance of the revised compact format 704 relative to appearance of the compact format 702. Alternatively, the revised compact format could be display relative to the submitted video content, or relative to both the compact format 702 and the submitted video content.

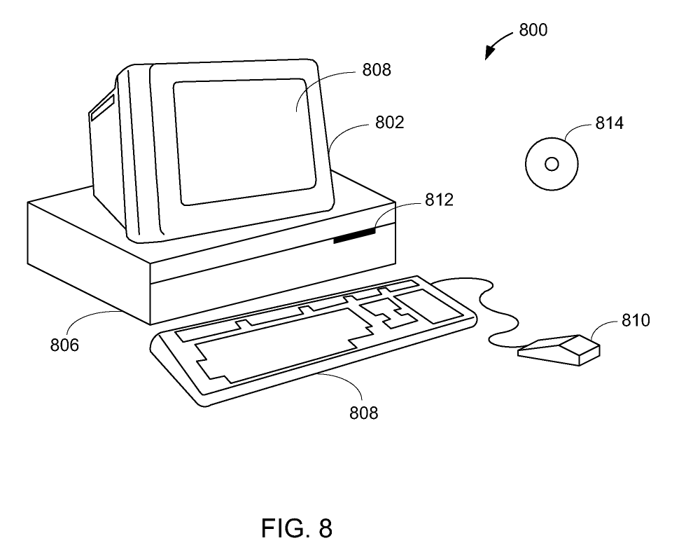

FIG. 8 shows an exemplary computer system. One or more of the exemplary computer systems are suitable for use with at least one embodiment of the invention. The computer system 800 includes a display monitor 802 having a single or multi-screen display 804 (or multiple displays), a cabinet 806, a keyboard 808, and a mouse 810. The cabinet 806 houses a drive 812, such as for receiving a CD-ROM 814, a system memory and a hard drive (not shown) which may be utilized to store and retrieve software programs incorporating computer code that implements the present invention, data for use with the invention, and the like. Although the CD-ROM 814 is shown as an exemplary computer readable medium, other computer readable digital video including floppy disk, tape, flash memory, system memory, and hard drive may be utilized.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage is that the invention provides increased convenience and efficiency by automating assessment of media defects, such as transcoding artifacts. Another advantage is that the invention facilitates sharing a reviewer's assessments concerning a video using a highlights video. The highlights video has a reduced file size that make it efficient for not only playback but also transmission over a network. Another advantage is that the invention provides an easily understandable visual experience of the assessment of transcoding artifacts. For example, the original natural timeline of the submitted video can be retained, and the appearance of the transcoding artifacts in the compact format can be displayed relative to the appearance of the submitted video content.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as failing within the scope of the invention.

```
APPENDIX A
− <movie type=“quicktime”>
− <tracks>
− <video enabled=“true” index=“0” type=“vide”>
  <track_id>1</track_id>
  <track_reference type=“chap”>4</track_reference>
  <language numeric=“0”>eng</language>
  <alternate_group>0</alternate_group>
− <matrix identity=“false”>
  <a>1.3328094482421875</a>
  <b>0.0</b>
  <u>0.0</u>
  <c>0.0</c>
  <d>1.0</d>
  <v>0.0</v>
  <tx>0.0</tx>
  <ty>0.0</ty>
  <w>1.0</w>
    </matrix>
  <data_size units=“bytes”>2165579</data_size>
  <duration units=“milliseconds”>25000.0</duration>
− <encoded_dimensions>
  <width>640</width>
  <height>480</height>
    </encoded_dimensions>
− <display_dimensions>
  <width>853</width>
  <height>480</height>
    </display_dimensions>
− <track_dimensions>
  <width>640</width>
  <height>480</height>
    </track_dimensions>
  <data_rate units=“Kb/s”>676.0</data_rate>
  <codec name=“avc1”>avc1</codec>
  <frame_rate>10.0</frame_rate>
  <field_dominance>progressive</field_dominance>
− <sample_description>
− <colr>
  <color_parameter_type>nclc</color_parameter_type>
  <matrix_index>6</matrix_index>
  <primaries_index>6</primaries_index>
  <transfer_function_index>1</transfer_function_index>
    </colr>
− <pasp>
  <horizontal_spacing>10000</horizontal_spacing>
  <vertical_spacing>7500</vertical_spacing>
    </pasp>
− <avcC>
  <profile>Baseline</profile>
  <compatability>224</compatability>
  <level>3.0</level>
    </avcC>
    </sample_description>
  <maximum_sample_size>42811</maximum_sample_size>
    </video>
− <sound enabled=“true” index=“1” type=“soun”>
  <track_id>2</track_id>
  <language numeric=“0”>eng</language>
  <alternate_group>0</alternate_group>
  <matrix identity=“true” />
  <data_size units=“bytes”>1657759</data_size>
  <duration units=“milliseconds”>125000.0</duration>
  <data_rate units=“Kb/s”>103.60994</data_rate>
  <codec name=“MPEG-4 audio”>mp4a</codec>
− <channel_layout name=“Stereo (L R)”>
  <channel name=“Left”>L</channel>
  <channel name=“Right”>R</channel>
    </channel_layout>
  <sample_rate units=“kilohertz”>44.1</sample_rate>
    </sound>
− <video enabled=“true” index=“2” type=“vide”>
  <track_id>3</track_id>
  <language numeric=“0”>eng</language>
  <alternate_group>0</alternate_group>
− <matrix identity=“false”>
  <a>0.4442596435546875</a>
  <b>0.0</b>
  <u>0.0</u>
  <c>0.0</c>
  <d>0.4444427490234375</d>
  <v>0.0</v>
  <tx>853.0</tx>
  <ty>0.0</ty>
  <w>1.0</w>
    </matrix>
  <data_size units=“bytes”>373232832</data_size>
  <duration units=“milliseconds”>25000.0</duration>
− <encoded_dimensions>
  <width>1920</width>
  <height>1080</height>
    </encoded_dimensions>
− <display_dimensions>
  <width>1920</width>
  <height>1080</height>
    </display_dimensions>
− <track_dimensions>
  <width>1920</width>
  <height>1080</height>
    </track_dimensions>
  <data_rate units=“Kb/s”>116635.0</data_rate>
  <codec name=“ProResHQ”>apch</codec>
  <frame_rate>1000.0</frame_rate>
  <field_dominance>progressive</field_dominance>
  <sample_description />
  <maximum_sample_size>981056</maximum_sample_size>
    </video>
− <chapter enabled=“true” index=“3” type=“text”>
  <track_id>4</track_id>
  <language numeric=“0”>eng</language>
  <alternate_group>0</alternate_group>
− <matrix identity=“false”>
  <a>1.0</a>
  <b>0.0</b>
  <u>0.0</u>
  <c>0.0</c>
  <d>1.0</d>
  <v>0.0</v>
  <tx>0.0</tx>
  <ty>480.0</ty>
  <w>1.0</w>
    </matrix>
  <data_size units=“bytes”>208</data_size>
  <duration units=“milliseconds”>25000.0</duration>
  <preload default_hints=“0” duration=“0” flags=“1” startTime=“−1” />
  <number_of_chapters>7</number_of_chapters>
    </chapter>
    </tracks>
  <matrix identity=“true” />
    </movie>
```

What is claimed is:

1. A media distribution system, comprising:
a media submission sub-system configured to facilitate review of a digital video stored in an electronic video file,
said media submission sub-system is configured to (i) receive a defect report pertaining to one or more defects in a digital video, the defect report indicating at least a defect location for each of the one or more defects in the digital video, and (ii) form a defect review video from the digital video based on the corresponding defect locations for the identified one or more defects in the digital video as identified in the defect report.

2. A method for facilitating review of a digital video stored in an electronic video file, said method comprising:
receiving a defect report pertaining to one or more defects in a digital video, the defect report indicating at least a defect location for each of the one or more defects in the digital video; and
automatically, through use of a computer, forming a defect review video from the digital video based on the corresponding defect locations for the identified one or more defects in the digital video as identified in the defect report.

3. A method as recited in claim 2, wherein said method further comprises:
inserting a chapter marker to the digital review video corresponding to each of the identified one or more defects in the digital video.

4. A method as recited in claim 2, wherein said forming the defect review video comprises:
inserting filler frames into the digital review video for regions of the digital video that are not associated with the identified one or more defects.

5. A method as recited in claim 2, wherein the digital video has a timeline, and wherein the defect review video also has the timeline but contains substantially less video content than does the digital video.

6. A method as recited in claim 2, wherein the digital video is an encoded version of a source video, and
wherein the digital review video includes at least two video tracks, a first video track pertains to video segments from the digital video pertaining to the one or more defects, and a second video track pertains to video segments from the source video that are time-synchronized with the video segments in the first video track.

7. A method as recited in claim 6, wherein the source video has a timeline, wherein the digital video and the defect review video have the same timeline, and wherein the defect review video contains substantially less video content than does the digital video.

8. A method as recited in claim 2, wherein the electronic file for the defect review video includes content for the defect review video and instructions for playback of the defect review video.

9. A method as recited in claim 2, wherein the digital video is an encoded version of a source video, and
wherein the digital review video includes at least two video tracks, a first video track pertains to video segments from the digital video pertaining to the one or more defects, and a second video track pertains to corresponding video segments from the source video.

10. A method as recited in claim 9, wherein the electronic file for the defect review video includes content for the defect review video and instructions for playback of the defect review video.

11. A method as recited in claim 10, wherein the instructions for playback indicate that on playing the defect review video, the first video track and the second video track are simultaneously played.

12. A method as recited in claim 10, wherein the instructions for playback indicate that on playing the defect review video, the first video track and the second video track are simultaneously played by an electronic device with media playback capability and a display device for presenting video content, with the first video track being displayed on a first portion of the display device while the second video track being displayed on a second portion of the display device.

13. A method for reviewing digital videos, comprising:
submitting digital video content to a digital video distribution system for transcoding and distribution in a compact format;
transcoding the submitted digital video content into the compact format;
reviewing transcoding artifacts, which are present in one or more video segments of the compact format;
identifying the one or more video segments having the transcoding artifacts; and
creating an electronic record of the transcoding artifacts for the identified segments.

14. A method as in claim 13, wherein said method further comprises:
reviewing audio defects, which are present in one or more video segments of the compact format; and
identifying the video segments having the audio defects.

15. The method as in claim 13, wherein said method further comprises:
automatically obtaining video clips of the identified segments of the compact format, based upon the electronic records.

16. The method as in claim 13, wherein said method further comprises:
automatically identifying segments of the submitted video content, corresponding to the identified segments of the compact format.

17. The method as in claim 16, wherein said method further comprises:
automatically obtaining video clips of identified segments of the submitted video content, based upon the electronic record.

18. The method as in claim 13, further comprising a step of automatically assembling video clips of the identified segments into a compact playable file, featuring the transcoding artifacts from the identified segments of the compact format.

19. The method as in claim 13, wherein said method further comprises:
automatically assembling video clips of the identified segments into a highlights video, featuring the transcoding artifacts from the identified segments of the compact format.

20. The method as in claim 13, wherein said method further comprises:
automatically arranging in parallel chronological order within a sequential playback file the identified segments of the compact format and corresponding identified segments of the submitted video content.

21. The method as in claim 13, wherein said method further comprises:
automatically synchronously pairing the identified segments of the compact format and corresponding identified segments of the submitted video content within a sequential playback file.

22. The method as in claim 13, wherein said method further comprises:
arranging a set of the identified segments of the compact format in a selected ordering; and
arranging the identified segments of the submitted video content in the selected ordering, wherein each of the identified segments of the submitted video content corresponds to a respective member of the set of identified segments of the compact format.

23. The method as in claim 13, wherein the submitted digital video content has an initial data size, and
wherein said method further comprises automatically assembling video clips of the identified segments into a compact playable file, wherein the compact playable file has a smaller data size, which is substantially smaller than approximately one tenth of the initial data size of the submitted digital content.

24. The method as in claim 13, wherein the submitted digital video content and the compact format have a common natural timeline, and wherein said method further comprises:
generating filler content; and
automatically assembling video clips of the identified segments together with the filler content into a compact playable file, wherein the filler content is generated so as to retain the natural timeline of the submitted digital video content in the compact playable file.

25. The method as in claim 13, wherein the submitted digital video content has an initial data size, and the submitted digital video content and the compact format have a common natural timeline, and wherein said method further comprises:
generating filler content; and
automatically assembling video clips of the identified segments together with the filler content into a compact playable file, wherein the filler content is generated sufficient to retain the natural timeline of the submitted digital video content within the compact playable file, wherein the filler content is generated having low data complexity relative to the identified segments, and wherein the data complexity is sufficiently low so that the compact playable file is substantially smaller than the submitted digital video content.

26. The method as in claim 13, wherein said method further comprises:
generating filler content;
automatically assembling video clips of the identified segments together with the filler content into a compact playable file; and
creating a chapter list of respective start points of each of the video clips, so as to provide for convenience in skipping to any of the start points, and skipping over the filler content, during playback of the compact file.

27. The method as in claim 13, wherein said method further comprises:
packaging the identified segments of the compact format, and corresponding identified segments of the submitted video content into a playable file; and
including instruction parameters in the file for automatically arranging playback of each of the identified segments of the compact format together with the corresponding identified segments of the submitted video content, so as to demonstrate any defects initially present in the submitted video content.

28. The method as in claim 13, wherein said method further comprises:
packaging identified segments of the compact format, and corresponding identified segments of the submitted video content into a playable file; and
including instruction parameters in the file for automatically arranging playback of each of the identified segments of the compact format together the corresponding identified segments of the submitted video content, so as to demonstrate appearance of the transcoding artifacts in the compact format, relative to appearance of the submitted video content.

29. The method as in claim 13, wherein said method further comprises:
packaging identified segments of the compact format, and corresponding identified segments of the submitted video content into a playable file; and
including instruction parameters in the file for automatically arranging side-by-side playback of each of the identified segments of the compact format together with the corresponding identified segments of the submitted video content, so as to demonstrate appearance of the transcoding artifacts in the compact format, relative to appearance of the submitted video content.

30. The method as in claim 13, wherein said method further comprises:
packaging the identified segments of the compact format, and corresponding identified segments of the submitted video content into a playable file; and
including instruction parameters in the file for automatically and simultaneously displaying playback of each identified segments of the compact format together with corresponding identified segments of the submitted video content.

31. The method as in claim 13, wherein said method further comprises:
pairing time codes of the identified segments of the compact format with substantially matching time codes of the identified segments of the submitted video content;
packaging the identified segments of the compact format, and corresponding identified segments of the submitted video content into a playable file; and
using the time codes for synchronously displaying playback of both the segments of the compact format and the segments of the submitted video content.

32. The method as in claim 13, wherein said method further comprises:
packaging identified segments of the compact format, and corresponding identified segments of the submitted video content into a playable file; and
including instruction parameters in the file for displaying during playback annotations characterizing severity of the transcoding artifacts.

33. The method as in claim 13, wherein the submitted video content has an initial display resolution,
wherein said transcoding the submitted digital video content into the compact format comprises encoding the submitted digital video content into a lower display resolution than the initial display resolution of the submitted video content, and
wherein said method further comprises:
packaging the identified segments of the compact format, and corresponding identified segments of the submitted video content into a playable file;
including instruction parameters in the file for formatting simultaneous playback display of the segments of the compact format together with corresponding segments of the submitted video content; and
including instruction parameters in the file for automatically scaling down the initial resolution of the video clips of the submitted video content during playback, so as to substantially match playback display of the lower video resolution of the video clips of the compact format.

34. The method as in claim 13, wherein said method further comprises:
packaging the identified segments of the compact format, and corresponding identified segments of the submitted video content into a playable file; and
including instruction parameters in the file for formatting simultaneous adjacent playback display of the segments of the compact format with corresponding segments of the submitted video content, each in substantially matching size display areas.

35. The method as in claim 13, wherein said method further comprises:
resubmitting a revised version of the digital video content;
identifying segments of the resubmitted video content using the electronic records;
packaging the identified segments of the resubmitted video content and corresponding identified segments of the submitted video content into a playable file; and
including instruction parameters in the file for automatically arranging playback of each of the identified segments of the resubmitted video content together with the corresponding identified segments of the submitted video content, so as to demonstrate appearance of the resubmitted video content, relative to appearance of the submitted video content.

36. The method as in claim 13, wherein said method further comprises:
re-transcoding the submitted digital video content into a revised compact format;
identifying segments of the revised compact format using the electronic record;
packaging the identified segments of the revised compact format and corresponding identified segments of the compact format into a playable file; and
including instruction parameters in the file for automatically arranging playback of each of the identified segments of the revised compact format together with corresponding identified segments of the compact format, so as to demonstrate appearance of the revised compact format relative to appearance of the compact format.

37. A computer readable medium including at least computer program code stored thereon for automating assessment of transcoding artifacts, said computer readable medium comprising:
computer program code of segments of submitted digital video content;
computer programs code for transcoding the submitted digital video content into a compact format, wherein the compact format includes transcoding artifacts;
computer program code for packaging segments of the compact format and corresponding segments of the submitted video content together into a playable file; and
computer program code for providing instruction parameters in the playable file for automatically arranging playback of each of the segments of the compact format, together with the corresponding segments of the submitted video content, so as to demonstrate appearance of the transcoding artifacts in the compact format, relative to appearance of the submitted video content.
